(19) United States
(12) Patent Application Publication
(10) Pub. No.: US 2009/0158600 A1
(43) Pub. Date: Jun. 25, 2009

(54) Kitchen implement with weight-adjustable handle

(76) Inventor: Alon Ben Ishai, Brooklyn, NY (US)

Correspondence Address: Steven Horowitz;Counselor at Law, 295 Madison Avenue, Suite 700, New York, NY, 10017, US

(21) Appl. No.: 12/004,785

(22) Filed: Dec. 20, 2007

(51) Int. Cl. B26B 3/00; B26D 1/00; B25G 1/00

(52) U.S. Cl. 30/314; 83/13; 16/111.1

(57) ABSTRACT

A chef's knife with a weight-adjustable handle may have a cutting component and a handle, the handle having an end cap and an internal handle assembly. The internal handle assembly may be located in a cavity defined by the outer housing and may include a tubular member and at least one weight connected thereto. The at least one weight may be movable within the handle and/or adjustable in magnitude by removal from the handle after opening of the closure portion and removal of the internal handle assembly. The weight and/or weight distribution of the handle and the knife may therefore be adjusted. To cut with the forward portion of the blade, the weight may be moved forward. To cut with the rear portion of the blade, the weight may be moved rearward. The knife may also be converted from a lightweight knife to a heavy style knife and vice versa.

### BACKGROUND OF THE INVENTION

The present invention generally relates to apparatus and methods for use of knives and other kitchen implements and, more particularly, to apparatus and methods of customizing the knives and other kitchen implements based on the type of use needed.

A chef's knife, usually, the largest knife in the kitchen, is an essential tool for any cook, whether professional or an ordinary non-professional. A chef's knife may have a wide blade between 8 and 10 inches long and may be the most suitable for the greatest variety of tasks. A high quality chef's knife, if maintained properly, can last a very long time.

A chef's knife should feel comfortable and balanced in the hand of the user. It should also feel heavy and solid enough and should not slip.

There are two well known styles or types of chef's knives—the Japanese chef's knife and the German chef's knife. Many Japanese chef's knife may be very lightweight and perfectly balanced. The advantage of this is that it may reduce hand fatigue. Some German chef's knife, in contrast, may be thick and heavy. One advantage of this may be durability—the ability to endure severe punishment in the kitchen. Whether the style is Japanese or German, it is clear that some chef's knives may be lightweight and some chef's knives may be heavy.

There is a need for a chef's knife that can combine the advantages and functions performed by different types of chef's knives.

### SUMMARY OF THE PRESENT INVENTION

In one aspect of the present invention, there is presented a kitchen implement, comprising: a cutting component; and a handle, the handle having a removable end cap and an internal handle assembly, the internal handle assembly including a tubular member and at least one weight connected to the tubular member, the at least one weight capable of being altered either in terms of a position of the at least one weight in relation to the tubular member and/or in terms of a magnitude of the at least one weight.

In a further aspect of the present invention, there is presented a method of cutting with a chef's knife, comprising: cutting with the chef's knife by holding a handle of the knife in a first position, the first position determining whether a front portion or a rear portion of the blade actively cuts; changing the weight of the handle and/or the weight distribution of the handle; and cutting with the chef's knife by holding the handle of the knife in a second position that determines whether the front portion or the rear portion of the blade actively cuts.

In a further aspect of the present invention, there is presented handle for a knife, the knife used to cut food, the handle comprising: a hollow outer housing, a cavity inside the outer housing; and at least one weight inside the cavity, the at least one weight being either movable within the cavity and/or removable from the cavity.

These and other features, aspects and advantages of the present invention will become better understood with reference to the following drawings, descriptions and claims.

### BRIEF DESCRIPTION OF THE DRAWINGS

FIG. 1 is a front view of the knife of the present invention;

FIG. 2 is a side view thereof, the other side being identical;

FIG. 3 is a vertical cross-sectional view thereof;

FIG. 4 is a horizontal cross-sectional view thereof;

FIG. 5 is an exploded view of the end cap and internal handle assembly of the knife of FIG. 1;

FIG. 6 is a vertical cross-sectional view of the knife of FIG. 1 except that the small and medium sized weights have been removed from the internal handle assembly;

FIG. 7 is a perspective view of a knife of FIG. 1 held by a user in a position whereby the front point of the blade tilts down;

FIG. 8 is a perspective view of the knife of FIG. 1 held by a user in a position whereby the back point of the blade tilts down;

FIG. 9 is a vertical cross-sectional view of the knife of the present invention showing an alternative embodiment of the internal handle assembly;

FIG. 10 is an exploded view of the end cap and internal handle assembly of the knife of FIG. 9;

FIG. 11 is a vertical cross-sectional view of the knife of the present invention showing a further alternative embodiment of the internal handle assembly in which a liquid replaces the weights; and

FIG. 12 is a vertical cross-sectional view of the knife of the present invention showing a further alternative embodiment of the internal handle assembly in which a powder replaces the weights;

FIG. 13 is a vertical cross-sectional view of the knife of the present invention showing a further alternative embodiment of the internal handle assembly in which a collection of small balls replaces the weights; and

FIG. 14 is a flow chart showing a method in accordance with the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The knife of the present invention may generally be used as a professional or non-professional chef's knife. It may serve the purpose of having a lightweight chef's knife and a heavier chef's knife. The knife of the present invention may be usable for cutting the foods that chef's knives are known to be used for.

In contrast to prior art kitchen implements, for example a chef's knife, that have a handle having a fixed weight and a fixed weight distribution, the kitchen implement of the present invention utilizes a handle that has an adjustable weight. In further contrast to the prior wherein the handle of the chef's knife has a fixed weight distribution, the handle of the chef's knife of the present invention may be adjustable as to its weight distribution. The chef's knife of the present invention may have a handle that incorporates a removable internal handle assembly. The internal handle assembly may include an at least one weight whose location is adjustable and which may be removed entirely or in part. In further contrast to the prior art, wherein a chef's knife may be styled like a Japanese chef's knife or a German chef's knife, the chef's knife of the present invention may accommodate the weight characteristics of both styles. In further contrast to the prior art, wherein a chef's knife may be handled in one typical position, the chef's knife of the present invention may be tilted into more than one position to adjust the weight distribution of the handle. For example, by moving forward the weight distribution of the handle with a tilt of the blade, it may be easier for the user to comfortably tilt the knife so that the forward or front portion of the blade does the active cutting. Similarly, by moving rearward the weight distribution with a tilt of the blade in the reverse direction (or by never tilting forward the blade in the first place) the rear portion of the blade may be positioned to do the active cutting. In contrast to the prior art, the kitchen implement of the present invention may save the need to purchase, store, use, clean and/or otherwise maintain additional kitchen implements.

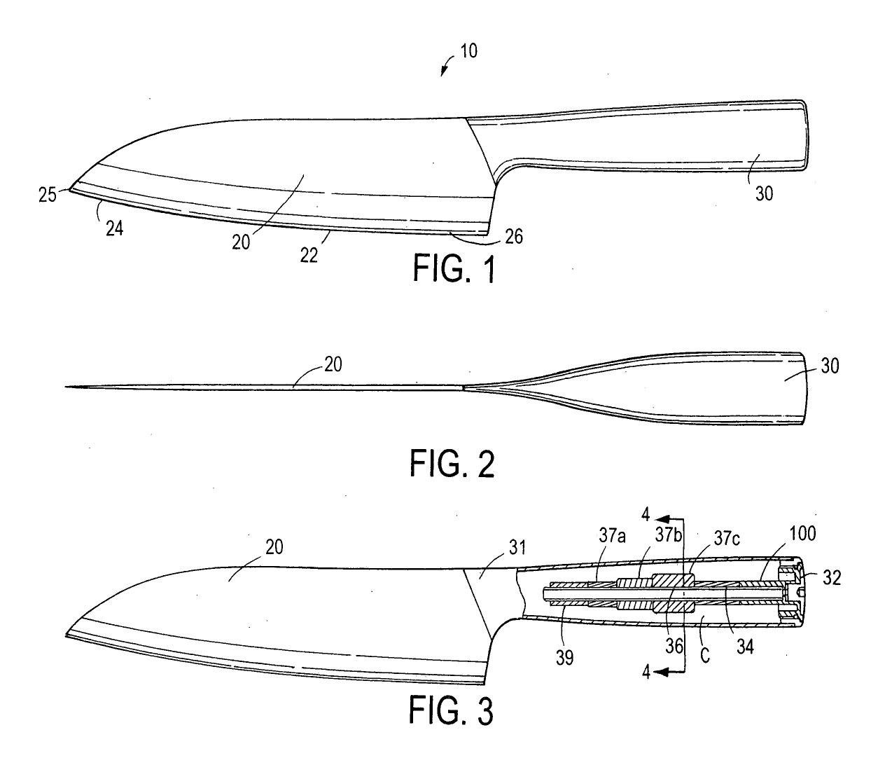

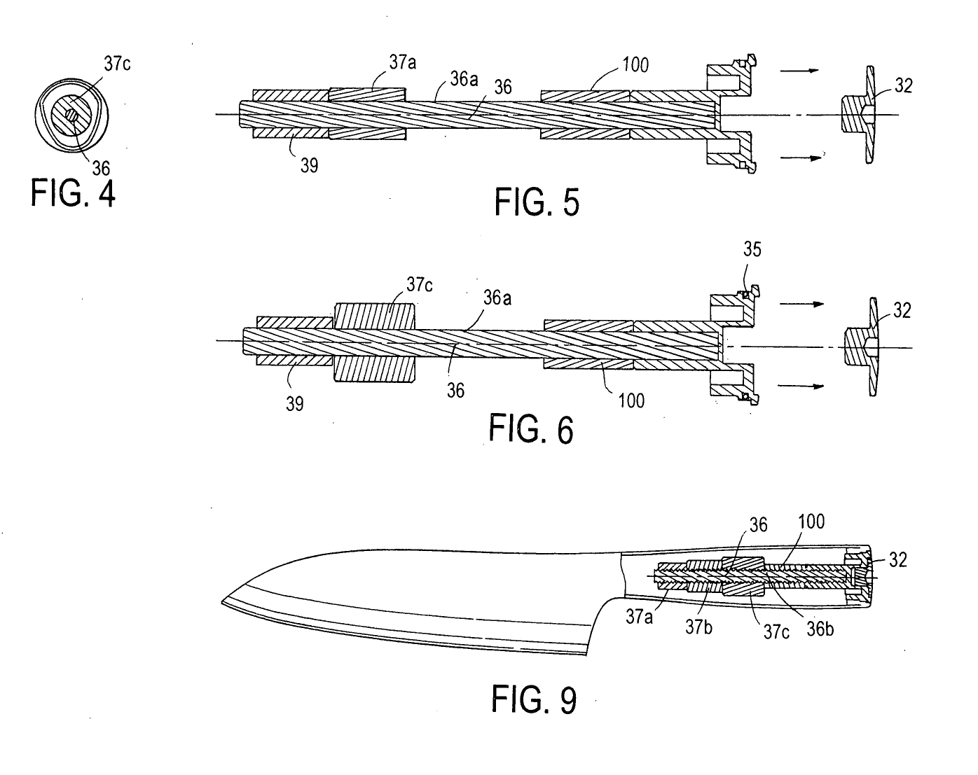

As seen from FIG. 1, kitchen implement 10 may include a cutting component 20 and a handle 30. Cutting component 20 may include blade 22 having front portion 24 and rear portion 26 of blade 22. Front portion 24 may in turn include point 25.

As seen from FIG. 3, handle 30 may include an outer housing 31. Outer housing may define a cavity C therein. Handle 30 may also include a removable closure portion 32 of outer housing 31 that allows access to what is inside the outer housing 31. As seen from FIG. 5, removable closure portion 32 may be an end cap 32. End cap 32 is a broad term that denotes any closure device on the distal end of handle 30. In certain embodiments, removable closure portion 32 may be a removable cap located along a side of outer housing 31, and preferably allows access to and removal of a movable or adjustable weight object within handle 30, as described below.

Handle 30 may also include a removable internal handle assembly 34. End cap 32 may attach to a distal end of internal handle assembly 34 by a friction fit that exploits a rubber O-ring 35 or end cap 32 may attach to internal handle assembly 34 or to handle 30 by other means such as a screw-on or other well known secure connection means. Internal handle assembly 34 may be located in cavity C within housing 31 and may include a tubular member 36 such as a shaft 36. Tubular member 36 may have a wide variety of shapes and may be made from a wide variety of materials.

Tubular member 36 may have removably attached thereon at least one weight 37. The at least one weight 37 may be annular so as to rotatably attach to tubular member 36 and may thereby slide axially along an outer surface of tubular member 36. In addition, the at least one weight 37 may encompass three weights of varying size, for example, small weight 37a, medium weight 37b and large weight 37c.

As seen from FIG. 3 and FIGS. 5 and 6, tubular member 36 may be fixed inside a further tube 100 secured within handle 30.

At a proximal end of handle 30, the at least one weight 37 may be held by a stopper 39 or by the internal walls of handle 30. In other embodiments, the at least one weight 37 may be held by virtue of a secure connection between end cap 32 and a bottom portion of internal handle assembly 34. It may be envisioned that the at least one weight 37 may in certain embodiments be held in place by the internal walls of handle 30.

The at least one weight 37 may be movable from one position to another position by any number of ways. For example, the at least one weight may be slidably attached to tubular member 36. In other embodiments, the at least one weight may be contained within tubular member 36.

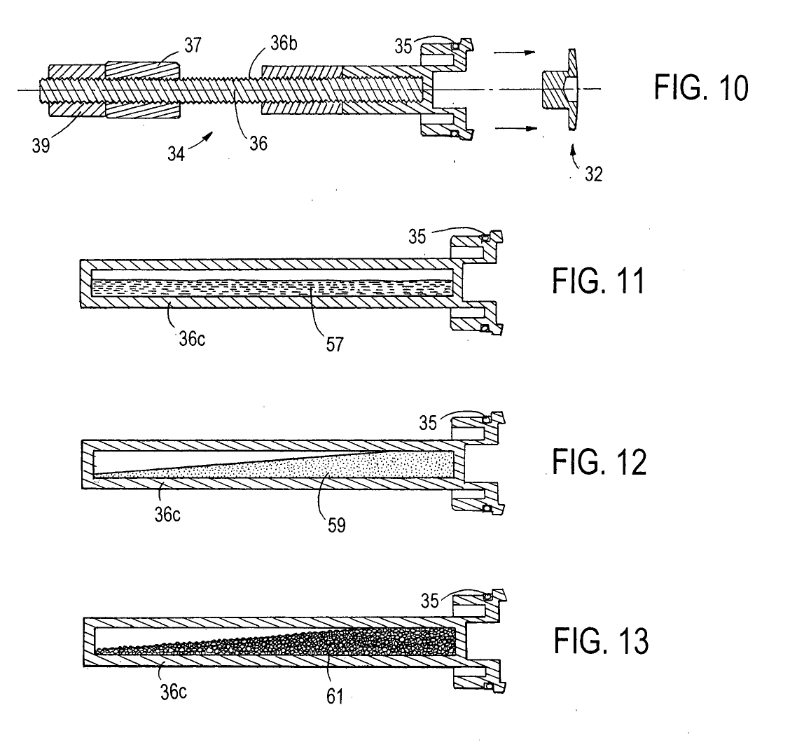

If the at least one weight 37 comprises three weights, 37a, 37b, 37c, then these three weights 37a, 37b, 37c may be removable in a number of ways. In certain embodiments, for example see FIG. 5 and FIG. 6, in order to accomplish the ability of weights to slide axially along the outer surface of tubular member 36, tubular member 36 may have a smooth outer surface 36a that accommodates an annular object such as a weight. In other embodiments, for example FIG. 9 and FIG. 10, the weights 37a, 37b, 37c have internal threading (not shown) that mates with external threading 36b of shaft 36. The position of each weight of the at least one weight 37 may be substantially fixed until a user manually moves such weight (or until a machine moves such weight).

In certain embodiments, for example FIG. 11, the at least one weight 37 may be a liquid such as water 57 inside tubular member 36c, or a powder such as sand 59, as in FIG. 12. In other embodiments, the at least one weight 37 may be a collection of small balls 61 or ball bearings inside tubular member 36c, as seen in FIG. 13. In either case, the weight distribution and/or the weight of handle 30 may be altered by changing the location of the weights, the liquid, the powder, the balls or other objects as the case may be within handle 30 or by removing portions or adding portions of these items from handle 30 entirely.

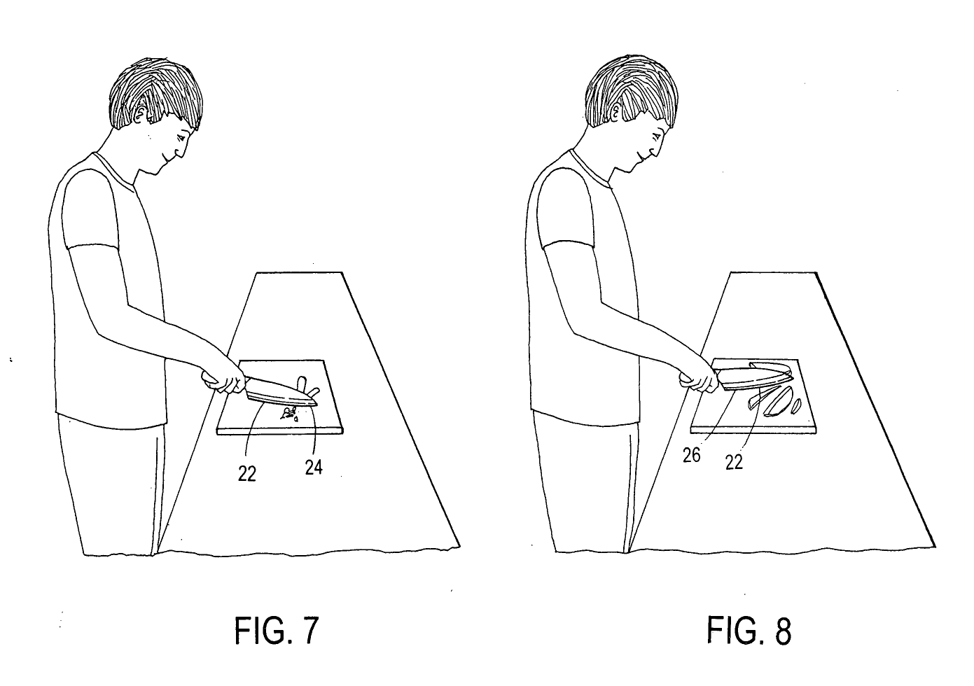

As seen from FIG. 7, a cook may tilt knife 10 to a first position so that front portion 24 of blade 22 actively cuts a small piece of vegetable. Conversely, as seen from FIG. 8, a cook may tilt knife 10 to a second position so that rear portion 26 of blade 22 actively cuts a piece of meat. First position need not determine use of front portion 24 of blade 22 and second position need not determine use of rear portion 26 of blade 22; it could be vice versa (i.e. first position dictates use of rear portion 26 etc.). Furthermore, the particular types of food shown are purely illustrative examples.

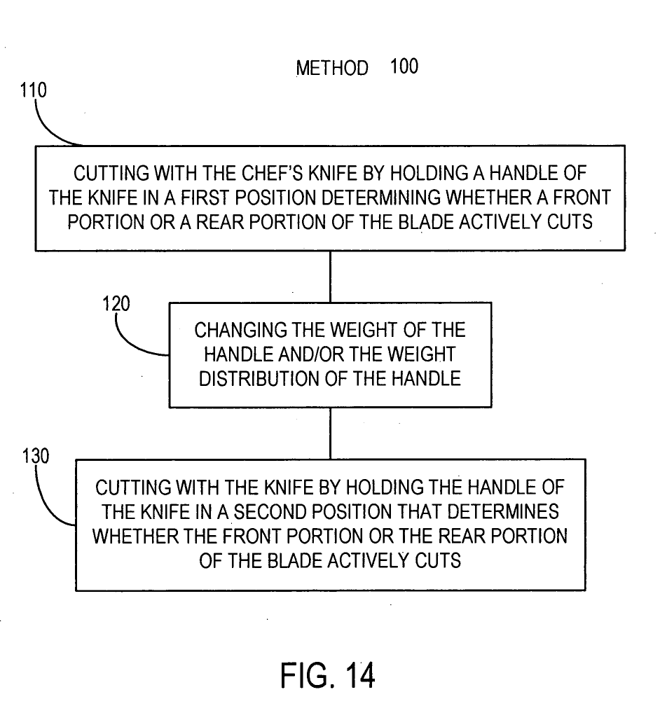

As can be seen from FIG. 14, the present invention can also be viewed as a method 100 of cutting with a chef's knife. In a first step 110, method 100 comprises cutting with the chef's knife 10 by holding a handle 30 of the knife 20 in a first position, the first position determining whether front portion 24 or rear portion 26 of blade 22 actively cuts. Examples of a first position are shown in FIGS. 7 and FIG. 8. In FIG. 7, the front portion 24 of blade 22 is pointing more downward than in FIG. 8, where the rear portion 26 is pointing more downward.

Method 100 further comprises a step 120 of changing the weight 37 of handle 30 and/or the weight distribution of handle 30. The weight and/or weight distribution may be changed in certain embodiments by simply shifting the position of the knife 10 thereby adjusting the location and/or quantity of weight object(s) 37 in the handle 30. The adjustment of the location and/or quantity of weight objects(s) may be accomplished after removing the end cap 32 and internal handle assembly 34. Another way of adjusting the location of weight objects within handle 30 is by moving magnets along an outer surface of handle 30, which magnets may attract weight objects within handle 30 and move them accordingly. It can also be envisioned that the weight and/or weight distribution of the handle 30 can be adjusted by adding weights to an external surface of the handle, such as using magnets.

Method 100 also includes the further step 130 of cutting with the chef's knife 10 by holding handle 30 of knife 10 in a second position that determines whether front portion 24 or rear portion 26 of blade 22 actively cuts. Examples of a second position are shown in FIG. 7 and FIG. 8. The second position may be one in which the blade points downward at a different angle with the floor than in the first position. The second position is understood to differ from the first position.

It should be understood, of course, that the foregoing relates to exemplary embodiments of the invention and that modifications may be made without departing from the spirit and scope of the invention as set forth in the following claims.

What is claimed is:

1. A kitchen implement, comprising:
a cutting component; and
a handle, the handle having a removable end cap and an internal handle assembly, the internal handle assembly including a tubular member and at least one weight connected to the tubular member, the at least one weight capable of being altered either in terms of a position of the at least one weight in relation to the tubular member and/or in terms of a magnitude of the at least one weight.

2. The kitchen implement of claim 1, wherein the at least one weight includes at least two weights of varying size.

3. The kitchen implement of claim 1, wherein a weight of the at least one weight is annular and is rotatably attached to the tubular member.

4. The kitchen implement of claim 3, wherein a weight of the at least one weight slides axially along the tubular member upon a shifting of position of the knife.

5. The kitchen implement of claim 1, wherein the tubular member is threaded on an outside of said tubular member.

6. The kitchen implement of claim 1, wherein the at least one weight is a fluid.

7. The kitchen implement of claim 1, wherein the at least one weight is a powder.

8. The kitchen implement of claim 1, wherein the at least one weight is a collection of balls.

9. A method of cutting with a chef's knife, comprising:
cutting with the chef's knife by holding a handle of the knife in a first position, the first position determining whether a front portion or a rear portion of the blade actively cuts;
changing the weight of the handle and/or the weight distribution of the handle; and
cutting with the chef's knife by holding the handle of the knife in a second position that determines whether the front portion or the rear portion of the blade actively cuts.

10. The method of claim 9, wherein changing the weight and/or weight distribution of the handle is accomplished by changing an internal handle assembly.

11. The method of claim 9, wherein changing the weight and/or weight distribution of the handle includes removing the end cap of the knife.

12. The method of claim 10, further comprising changing the location and/or magnitude of a weight inside the handle.

13. The method of claim 12, further comprising changing the quantity of weights inside the handle.

14. The method of claim 12, further comprising changing the location of weight inside the handle.

15. A handle for a knife, the knife used to cut food, the handle comprising:
an outer housing defining a cavity therein; and
at least one weight inside the cavity, the at least one weight being either movable within the cavity and/or removable from the cavity.

16. The handle of claim 15, wherein the housing includes a removable closure portion whose removal allows access to the at least one weight from outside the handle.

17. The handle of claim 15, wherein the at least one weight includes an annular object that can slides axially along a shaft inside the cavity.
